(19) United States
(12) Patent Application Publication
(10) Pub. No.: US 2013/0173901 A1
(43) Pub. Date: Jul. 4, 2013

(54) MULTI-PROCESSOR COMPUTER SYSTEMS AND METHODS

(71) Applicants: Raphael Gay, Fort Collins, CO (US); Robert J. Horning, Fort Collins, CO (US)

(72) Inventors: Raphael Gay, Fort Collins, CO (US); Robert J. Horning, Fort Collins, CO (US)

(21) Appl. No.: 13/821,506

(22) PCT Filed: Nov. 1, 2010
(86) PCT No.: PCT/US10/55021

§ 371 Date: Mar. 7, 2013

(51) Int. Cl. G06F 9/44

(52) U.S. Cl. CPC G06F 9/4405
USPC 713/2

(57) ABSTRACT

Multi-processor computer systems and methods are provided. A multi-processor computer system can include a plurality of communicatively coupled processors (110_{1-N}), each coupled to a common motherboard (120) and each associated with a memory (140_{1-N}). The system can include a boot code (130) executable from at least one of a standard mode and an independent mode. The plurality of communicatively coupled processors can execute one instance of the boot code in standard mode and at least a portion of the plurality of communicatively coupled processors can execute one instance of the boot code in independent mode.

### BACKGROUND OF THE INVENTION

### Description of the Related Art

Computer systems having multiple processor sockets form the backbone of the high performance computing industry. The installation of multiple processors into a single system provides considerably greater computational power than systems offering only single processors. Processor manufacturers have integrated the multi-processor capability directly into the chip architecture, Intel's QuickPath Interconnect (“QPI”) and AMD's HyperTransport provide just two examples of how chip manufacturers have sought to leverage multi-processor systems.

Chip manufacturers recognize the value and importance of multi-processor systems, and price processors having the capability to interconnect with one or more additional processors accordingly. Often a processor having its multi-processor interconnect capability disabled can be purchased at a discount over the identical processor having its multi-processor interconnect capability enabled. Where a single, interconnect disabled, processor is supplied in a system, a user desiring to expand the system to a multi-processor system is left with the unenviable (and costly) choice of either replacing the entire system with a factory configured multi-processor system, or replacing the existing, interconnect disabled processor with a new, interconnect enabled processor and then adding a second, similar processor. Both options are costly and inconvenient for the user.

### BRIEF DESCRIPTION OF THE DRAWINGS

Advantages of one or more disclosed embodiments may become apparent upon reading the following detailed description and upon reference to the drawings in which:

FIG. 1 is a block diagram depicting an illustrative multi-processor computer system, according to one or more embodiments described herein;

FIG. 2 is a block diagram depicting another illustrative multi-processor computer system, according to one or more embodiments described herein;

FIG. 3 is a flow diagram depicting an illustrative multi-processor computer method, according to one or more embodiments described herein; and

FIG. 4 is a flow diagram depicting another illustrative multi-processor computer method, according to one or more embodiments described herein.

### DETAILED DESCRIPTION

High performance computing platforms increasingly make use of multi-processor capable system architecture. The use of multiple processors within a system adds considerable computational horsepower without the additional costs of attempting to construct a similar system using single processor systems. As used herein, the term “processor” can include any computing device capable of executing one or more instruction sets or sequences of instructions. The term “processor” can therefore include central processing units (CPUs) as well as any other processor configured to execute an instruction.

Processor manufacturers understand the importance of multiple processor systems and often offer processors with interconnect pathways. At times, the processor manufacturer disables the interconnect pathway and offers the processor at a significant discount. Users purchasing a multiple processor capable system with only a single factory processor installed may find that the interconnect pathway on the installed processor has been disabled by the processor manufacturer, thereby limiting the user's ability to subsequently upgrade the system to take advantage of the enhanced performance of a multi-processor system.

The ability to partition a computing device into independent computing subsystems provides flexibility, and sometimes a financial advantage, to users whose computing needs evolve over time or are heterogeneous. Computer partitioning is mostly an expensive proposition reserved for high-end, low-volume systems. The cost of such systems is reflective of the use of specialized processors, chipsets and interconnects required to achieve partitioning. Input/output (I/O) or interconnect solutions for instance, generally require the use of duplicate resources to provide independent resource sets when in partitioned mode. Systems having the ability to use high-volume, low cost, non-partitioned aware, components would drastically reduce the cost of a system with partitioning capabilities.

Multi-processor systems may have unique capabilities, such as hard drive expandability or high graphics card power budgets that are often unavailable on single processor systems. Users desiring such capabilities may purchase a multi-processor system but configure the system with only one processor. Such a solution is cost ineffective from a user's perspective, as they will have paid for unused multi-processor support capability including high layer count printed circuit boards, second processor voltage regulation, expanded motherboard and chassis, additional power supply rails, etc. The provision of systems having these untapped capabilities available for use in providing additional independent computers therefore provides a significant economy to the end user.

A multi-processor computer system is provided. The multi-processor computer system can include a plurality of communicatively coupled processors, each coupled to a common motherboard and each associated with a memory. The system can include a boot code executable from at least one of a standard mode and an independent mode. The plurality of communicatively coupled processors can execute one instance of the boot code in standard mode and at least a portion of the plurality of communicatively coupled processors can execute one instance of the boot code in independent mode.

As used herein, the term “motherboard” can refer to any printed circuit board containing one or more integrated circuits and to which other boards may be coupled. An example might include, but is not limited to, the main printed circuit board containing the basic circuits and expansion ports included in a computing device.

A multi-processor computer method is also provided. The method can include entering an independent mode. Within the independent mode, the method can include retrieving a first boot code from a first boot code storage device and retrieving a second boot code from a second boot code storage device. The method can include executing the first boot code on a first group of processors selected from a plurality of processors coupled to a motherboard while contemporaneously executing the second boot code on a second group of processors selected from the plurality of processors coupled to the motherboard.

Another mufti-processor computer system is also provided. The multi-processor computer system can include two communicatively coupled processors coupled to a common motherboard. The system can further include a first boot code and a first memory accessible to a first of the two communicatively coupled processors. The two communicatively coupled processors can be configured to execute one instance of the first boot code when in a standard mode. A first input/output (I/O) controller can be coupled to the two communicatively coupled processors when in the standard mode. The system can further include a partitioning module. The partitioning module can include a second boot code and a second input/output controller that can be coupled to the second processor when in the independent mode. The second of the two communicatively coupled processors can be configured to execute one instance of the second boot code when in the independent mode. The system can further include a user interface to permit a user to reversibly alternate between at least one of the standard mode or the independent mode.

As used herein, the term “communicative coupling”, or a connection by which devices are “communicatively coupled”, is one by which electromagnetic signals, physical communications, logical communications, or combinations thereof may be transmitted and/or received. Devices referred to as being communicatively coupled to each other can be either directly coupled or coupled through an intermediary physical or logical device. For example, devices communicatively coupled to a motherboard can include devices either directly connected to the motherboard, or communicatively coupled to a daughterboard that is, in turn, communicatively coupled to the motherboard. A communicative coupling may include a physical interface, an electrical interface, a data interface, or combinations thereof sufficient to allow intermittent or continuous communication or control between a plurality of devices. For example, two entities can be communicatively coupled by being able to communicate signals to each other directly or through one or more intermediate entities like a processor, operating system, a logic device, software, or other entity.

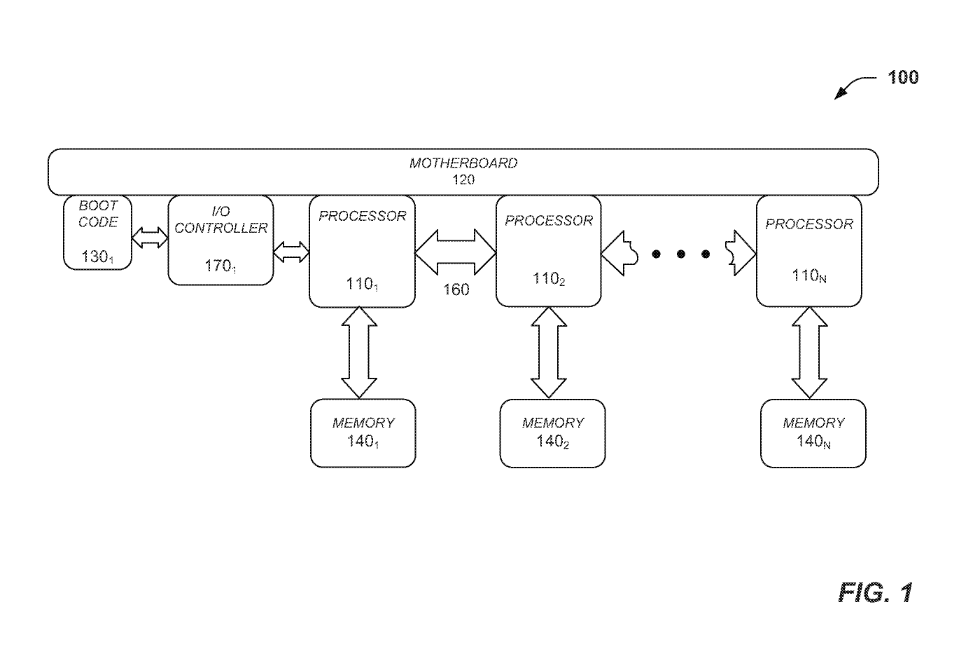

FIG. 1 is a block diagram depicting an illustrative multi-processor computer system 100, according to one or more embodiments. The system can include a plurality of processors 110 (labeled 110_{1-N} in FIG. 1) communicatively coupled to a motherboard 120. All or a portion of the plurality of processors 110 can be coupled to a boot code 130₁. Additionally, all or a portion of the plurality of processors 110 can be associated with a memory 140 (labeled 140_{1-N} in FIG. 1). At least a portion of the plurality of processors 110 can be coupled, connected or otherwise linked via one or more processor-to-processor interconnects 160. At least a portion of the plurality of processors 110 can be linked to at least one input/output (I/O) controller 170₁. In the embodiment depicted in FIG. 1, a first portion of the plurality of processors 110 can access and execute the boot code 130₁.

The plurality of processors 110 can include any number of physically separate or distinct processors communicatively coupled to a common motherboard 120. In at least some embodiments, all or a portion of the plurality of processors 110 can be physically disposed on a separate circuit board (often referred to as a “daughter board”) that is communicatively coupled to the motherboard 120. In at least some embodiments, all or a portion of the plurality of processors 110 can be disposed in sockets or similar receptacles coupled to the motherboard 120. The plurality of processors 110 can include one or more central processing units (CPUs), or any other type of electronic or logical device configured to execute a sequence containing one or more instructions.

In at least some embodiments, at least a portion of the plurality of processors 110 can include a processor-to-processor interconnect 160 enabling coupling or linkage of a processor to at least one other processor thereby forming a multi-processor computing device. These processor-to-processor interconnect 160 can include any number of systems, devices, or any combinations of systems and devices configured to permit the collaborative execution of one or more instruction sets across two or more processors. Example processor-to-processor interconnects 160 can include, but are not limited to the QuickPath Interconnect (“QPI”) offered by Intel® and the HyperTransport offered by AMD®.

In at least some embodiments, the plurality of processors 110 can include one or more processors having a disabled processor-to-processor interconnect feature. Processors having a disabled processor-to-processor interconnect feature are often priced lower, at times significantly lower, than comparable processors having an enabled processor-to-processor interconnect feature. The cost savings of such disabled processors makes their use economically attractive in computing systems that may have multiple processor sockets but have only one installed, on-board processor at the time of delivery to the user. While the use of a disabled processor may be financially attractive to a system manufacturer, such use often places a user desiring to expand such a system at a significant financial penalty—in such instances, the user is left with the choice of replacing the entire computing system with a multi-processor computing system or replacing the disabled processor with an enabled processor followed by adding a new enabled processor.

The boot code 130₁ can include one or more instruction sets configured for execution by one or more of the plurality of processors 110 when power is initially supplied to at least a portion of the plurality of processors 110. In some embodiments, at least a portion of the plurality of processors 110 can access the boot code via an input/output controller 170₁. For example, the boot code 130₁ can be stored in a read-only memory (ROM) location accessible via the I/O controller 170₁. In other embodiments, although not shown in FIG. 1, the boot code 130₁ can be accessed directly by at least one of the plurality of processors 110. The boot code 130₁ can, among other things, include one or more instructions loading input/output device drivers, one or more bus drivers, one or more non-volatile storage device drivers, or any combination thereof.

The memory 140 can be any form or type of volatile or non-volatile storage coupled to the processor 110. In at least some embodiments, the memory 140 can be exclusively associated with a specific processor 110, for example memory 140₁ can be exclusively associated with processor 110₁, memory 140₂ can be exclusively associated with processor 110₂, and so on. In other embodiments, the memory 140 can be associated with a group of processors selected from the plurality of processors 110. In some embodiments, the memory 140 can be disposed in whole or in part within the processor 110. The memory 140 can include, in whole or in part, a cache, for example a central processing unit (CPU) cache disposed within the CPU itself.

The processor-to-processor interconnect 160 can include any system or device suitable for providing a bidirectional serial/parallel high-bandwidth, low-latency point-to-point link between some or all of the plurality of processors 110. In some embodiments, the processor-to-processor interconnect 160 can include one or more data transfer layers, for example the Intel® QPI processor-to-processor interconnect having up to five layers: a physical layer, a link layer, a routing layer, a transport layer, and a protocol layer. In some embodiments, the processor-to-processor interconnect 160 can include one or more systems or devices incorporated into some or all of the plurality of processors, the motherboard, or both. For example, processors supplied by Intel® and AMD® may have onboard processor-to-processor interconnect systems or devices. Any or all of the processor-to-processor interconnects 160 can be enabled or disabled at the time of manufacture.

The input/output controller 170₁ can include any system, device or combination of systems and devices configured to couple one or more of the plurality of processors 110 to at least one input/output (I/O) device. As depicted in FIG. 1, in some instances the I/O controller 170₁ can provide some or all of the plurality of processors access to all or a portion of the boot code 130₁. Example I/O devices coupled to at least one of the plurality of processors 110 via the I/O controller 170 can include, but are not limited to, storage devices such as hard disk drives or solid state drives, one or more audio interfaces, one or more networking interfaces, one or more communications interfaces such as IEEE 1394 (Firewire®) or Universal Serial Bus (USB) communications interfaces. The I/O controller 170₁ can include one or more Southbridge controllers.

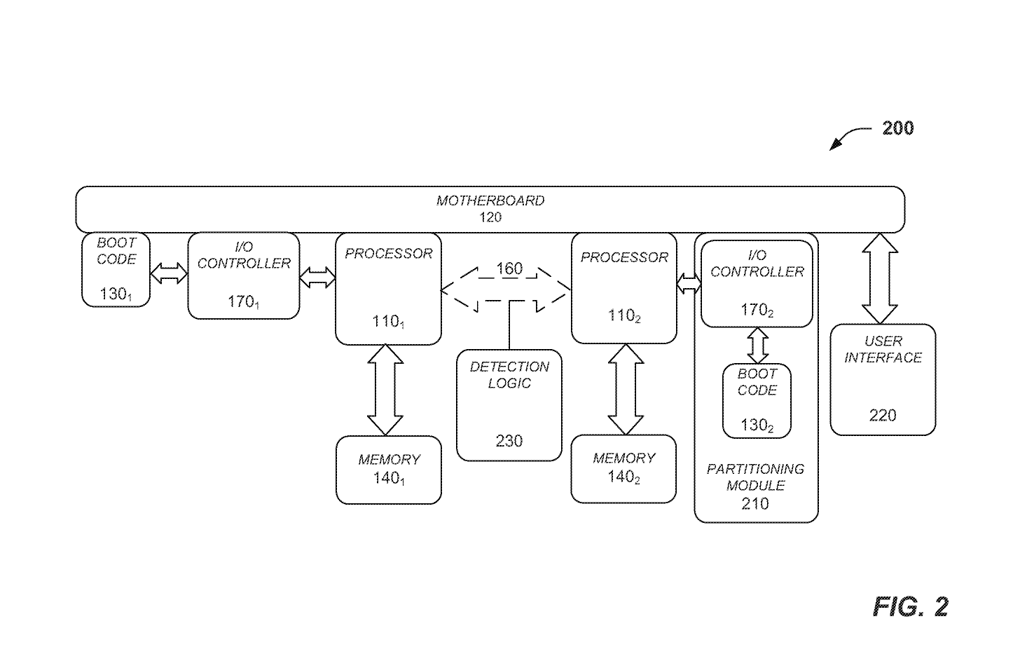

FIG. 2 is a block diagram depicting another illustrative multi-processor computer system 200, according to one or more embodiments. The system 200 depicts an illustrative dual processor computing system. The system 200 can include two processors 110₁₋₂ coupled to a common motherboard 120. A partitioning module 210 including, but not limited to, a second boot code 130₂ and a second I/O controller 170₂ can also coupled to the motherboard 120. The second I/O controller 170₂ can be logically coupled to the second processor 110₂. A user interface 220 can be used to configure the system 200, for example to configure the system 200 as either a single boot, dual-processor configuration or a dual boot, single partitioned processor configuration. In some embodiments, the system 200 can include detection logic 230 to detect the placement of the partitioning module 210 within the system 200.

Although the system 200 will be described in detail with regards to a dual processor system, any number of processors could be similarly grouped, partitioned, and provided with exclusive access to necessary system resources such as power, memory, and the like as needed to provide a physically and logically independent computing device within the system 200. Additionally, while the system 200 will be described in detail with regards to a single partition system created using a single partitioning module 210, any number of similar partitioning modules 210 could be used on a system containing three or more processors to provide at least three partitioned, independently bootable processors, each providing a physically and logically independent computing device, all coupled to a common motherboard 120.

The partitioning module 210 can include any number of systems, devices, or combinations of systems and devices necessary to independently boot at least a portion of the plurality of processors 110, for example, one of the two illustrative processors 110₁₋₂ depicted in FIG. 2. For example, the first boot code 130₁ can be executed on a first group of processors selected from the plurality of processors 110 to provide a first independent computing device coupled to motherboard 120. In a like manner, the second boot code 130₂ disposed within partitioning module 210 can be executed on a second group of processors, selected from the plurality of processors 110 to provide a second independent computing device coupled to motherboard 120. At times, the first boot code 130 can be executed by processor 110₁ contemporaneously with the execution of the second boot code 130₂ by processor 110₂.

As illustratively depicted in FIG. 2, the partitioning module 210 can include a second boot code 130₂ and a second I/O controller 170₂. Using the second I/O controller 170₂, the second group of processors 110₂ can access the second boot code 130₂. Such access can permit the booting of the second group of processors 1102 independent from the booting of the first group of processors. Extending both the number of processors 110 and the number of partitioning modules 210 within the system 200, any number of processor groups 110_{N} could be similarly independently booted using, for each group of processors, a dedicated boot code 130_{N} accessed via a dedicated I/O controller 170_{N}.

Although only a second boot code 130₂ and a second I/O controller 170₂ are depicted in FIG. 2, the partitioning module 210 can also include one or more additional devices, for example one or more memory devices, one or more memory controllers, additional I/O controllers, or combinations thereof.

The partitioning module 210 can be a discrete board mounted component or integrated into another board mounted component. The partitioning module 210, in some embodiments, can be a socket-mount device couplable to an open socket coupled to the common motherboard 120. In at least some embodiments, the partitioning module 210 can be a user installable device.

The user interface 220 can provide the system user with the ability to add or remove partitions within the system 200. For example, even though multiple processors 110 may be deployed in system 200, there may be occasions where not booting one or more groups of processors may be advantageous. In such instances, the user, via the user interface 220, can configure new partitions, delete existing partitions, or interrupt the booting of existing partitions within the system. In some embodiments, the user can make the desired changes to the partition structure or booting sequence via the user interface 220 then reboot the system 200 to enable the entered changes.

The detection module 250 can include any number of systems, devices or any combination of systems and devices configured to detect the insertion of one or more partitioning modules 210 within the system 200. In at least some embodiments, the detection module 250 can interrupt one or more processor-to-processor interconnects 160, thereby enabling the booting of at least a portion of the plurality of processors 110 (e.g. the second group of processors) as a physically discrete computing device coupled to a common motherboard 120. In other embodiments, where no processor-to-processor interconnects 160 are present, or where the processor-to-processor interconnects 160 between the plurality of processors has been disabled by the processor manufacturer, the detection logic 250 can ensure that only one boot code 130 and one I/O controller 170 are coupled to each group of processors 110.

Thus, the partitioning module 210, user interface 220, and detection module 230 can work synergistically to create or remove partitions between two or more groups of processors 110 disposed on a common motherboard 120. The partitioning module 210 can provide all or a portion of the resources necessary to provide independent boot capabilities to one or more groups of processors 110. The user interface can provide the user access to the partitioning scheme, permitting the user to easily and conveniently add, delete, or change the partitions between the groups of processors 110. The detection logic 250 can provide a level of assurance that the partitioning communication pathways have either been established (e.g. establishing the coupling between a processor group, an I/O controller 170, and a boot code 130) or broken (e.g. interrupting the processor-to-processor interconnect linking processors in different processor groups).

The absence of a processor-to-processor interconnect 160 does not impact the operation of the system 200, since each processor 110 is allocated the necessary system resources (e.g. boot code 130, I/O controller 170, and memory) required to successfully boot as an independent computing device despite the fact that both processors share a common motherboard 120.

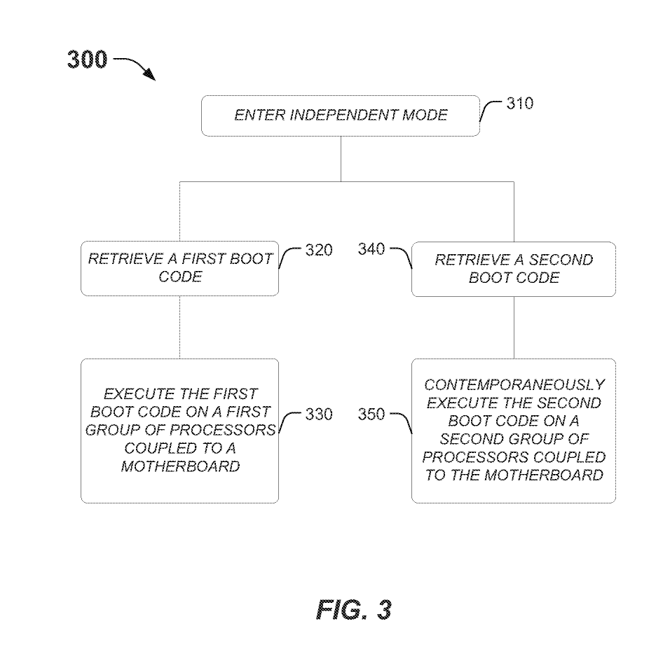

FIG. 3 is a flow diagram depicting an illustrative multi-processor computer method 300, according to one or more embodiments. In some embodiments, a computing system having multiple processors 110 can be partitioned such that two or more processor groups are independently bootable. Independently booting two or more groups of processors 110 sharing a common motherboard 120 can provide additional computational power, even in systems where the processor-to-processor interconnects 160 have been disabled by the processor manufacturer.

The system can enter an independent mode at 310. Entry into the independent mode can be manual, for example entry based upon system user input into a user interface 220. Entry into the independent mode can also be partially or completely autonomous, for example where detection logic 250 detects the coupling of a partitioning module 210 to the motherboard 120. In either event, a boot code 130 and an I/O controller 170 can be manually or automatically assigned to each of the processor groups. Although not depicted in FIG. 3, the system may require a reboot after being placed in independent mode to properly boot each of the processor groups.

After entry into independent mode, a first boot code 130₁ can be retrieved at 320. The first boot code 130₁ can be associated with a first group of processors 110₁ (recall that a processor “group” can contain as few as one processor 110). The first boot code 130₁ can be retrieved from a first boot code storage device. The first boot code storage device can be a unique location accessible only by the first processor group 110₁. In some embodiments, the first boot code 130₁ can be accessed directly by the first group of processors 110₁, while in other embodiments, the first boot code 130₁ can be accessed via one or more first I/O controllers 170₁.

After retrieval at 320, the first boot code 130₁ can be executed on a first group of processors 110₁ coupled to a motherboard 120 at 330. The execution of the first boot code 130₁ on the first group of processors 110₁ can provide a first physically isolated, independent computing device within the system.

Contemporaneous with or subsequent to the retrieval of the first boot code 130₁ at 320, a second boot code 130₂ can be retrieved at 340. The second boot code 130₂ can be associated with a second group of processors 110₂. The second boot code 130₂ can be retrieved from a second boot code storage device. The second boot code storage device can be a unique location accessible only by the second processor group 110₂. In some embodiments, the second boot code 130₂ can be accessed directly by the second group of processors 110₂, while in other embodiments, the second boot code 130₂ can be accessed via one or more second I/O controllers 170₂.

After retrieval at 340, the second boot code 130₂ can be executed on the second group of processors 110 coupled to a motherboard 120 at 350. The first group of processors 110₁ and the second group of processors 110₂ can be coupled to a common motherboard 120. The execution of the second boot code 130₂ on the second group of processors 110₂ can provide a second physically isolated, independent computing device within the system.

Although the method described with regard to FIG. 3 refers to a dual processor system, in more general terms, the method 300 can be extended to cover any number of partitioned processors coupled to a common motherboard 120. By providing a group of processors 110_{N} access to a single executable boot code 130_{N} stored in a memory location accessible only by the group of processors 110_{N}, a virtually unlimited number of independent, physically isolatable, computing devices sharing a common motherboard 120 can be created.

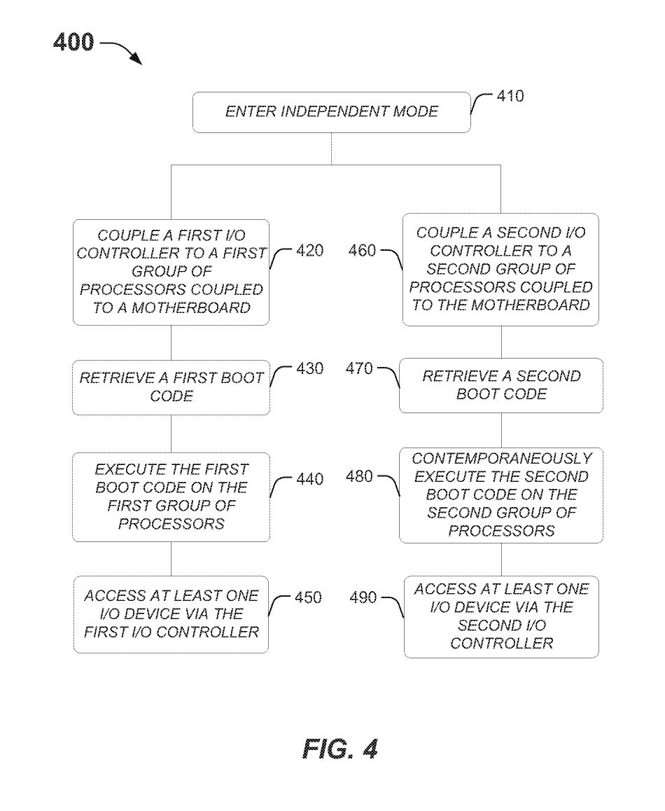

FIG. 4 is a flow diagram depicting another illustrative multi-processor computer method 400, according to one or more embodiments. In some embodiments, a computing system having multiple processors 110 can be partitioned such that a minimum of two processor groups are physically isolatable and independently bootable. Independently booting a plurality of processor groups 110_{1-N} sharing a common motherboard 120 can provide additional computational power in the system, even where the processor-to-processor interconnects 160 have been disabled by the processor manufacturer.

The system can enter an independent mode at 410. Entry into the independent mode at 410 can be manual, for example entry based upon system user input into a user interface 220. Entry into the independent mode at 410 can also be partially or completely autonomous, for example where detection logic 250 detects the coupling of a partitioning module 210 to the motherboard 120. In either event, a boot code 130 and an I/O controller 170 can be manually or automatically assigned to each of the processor groups. Although not depicted in FIG. 4, the system may require a reboot after being placed in independent mode to properly boot each of the processor groups.

A first I/O controller 170₁ can be coupled to a first group of processors 110₁ at 420. The first group of processors 110₁ can be coupled to a motherboard 120. The first I/O controller 170₁ can, among other things, provide the first group of processors 110₁ access to a first boot code storage location. In at least some embodiments, the first boot code storage location can be accessible only to the first group of processors 110₁. In some embodiments, the first I/O controller 170₁ can be coupled to one or more first I/O devices, for example a network interface device such as an Ethernet interface.

The first boot code 130₁ can be retrieved by the first group of processors 110₁ from the first boot code storage location at 430. In some embodiments, the first boot code 130₁ can be accessed directly by the first group of processors 110₁, while in other embodiments the first boot code 130₁ can be accessed via the first I/O controller 170₁.

After retrieval at 430, the first boot code 130₁ can be executed by the first group of processors 110₁ coupled to a motherboard 120 at 440. The execution of the first boot code 130₁ by the first group of processors 110₁ can provide a first physically isolated, independent computing device within the system.

At least one first I/O device can be accessed by the first group of processors 110₁ via the first I/O controller 170₁ at 450. In at least some embodiments, the first I/O device can include one or more network interfaces, for example one or more Ethernet interfaces. In other embodiments, the first I/O device can include one or more communications busses, for example one or more communications busses coupled to additional I/O devices.

Contemporaneous with or subsequent to the coupling of the first I/O controller 170₁ to the first group of processors 110₁ at 420, a second I/O controller 170₂ can be coupled to a second group of processors 110₂ at 460. The second group of processors 110₂ can be coupled to a common motherboard 120 shared with the first group of processors 110₁. The second I/O controller 170₂ can, among other things, provide the second group of processors 110₂ with access to a second boot code storage location. In at least some embodiments, the second boot code storage location can be accessible only to the second group of processors 110₂. In some embodiments, the second I/O controller 170₂ can be coupled to one or more second I/O devices, for example a network interface device such as an Ethernet interface.

Contemporaneous with or subsequent to the retrieval of the first boot code 130₁ at 430, the second boot code 130₂ can be retrieved by the second group of processors 110₂ from the second boot code storage location at 470. In some embodiments, the second boot code 130₂ can be accessed directly by the second group of processors 110₂, while in other embodiments the second boot code 130₂ can be accessed via the second I/O controller 170₂.

Contemporaneous with or subsequent to the execution of the first boot code 130₁ by the first group of processors 110₁ at 440, the second boot code 130₂ can be executed by the second group of processors 110₂ coupled to the motherboard 120 at 480. The execution of the second boot code 130₂ by the second group of processors 110₂ can provide a second physically isolated, independent computing device within the system.

At least one second I/O device can be accessed by the second group of processors 110₂ via the second I/O controller 170₂ at 490. In at least some embodiments, the second I/O device can include one or more network interfaces, for example one or more Ethernet interfaces. In other embodiments, the second I/O device can include one or more communications busses, for example one or more communications busses coupled to additional I/O devices.

Although the method 400 described with regard to FIG. 4 refers to a system containing only two processors (110₁₋₂), in more general terms, the method 400 can be extended to cover any number of partitioned processors coupled to a common motherboard 120. By providing a group of processors 110_{N} access to a single executable boot code 130_{N} stored in a boot code storage location accessible only by the group of processors 110_{N}, a virtually unlimited number of independent, physically isolatable, computing devices sharing a common motherboard 120 can be created.

What is claimed is:

1. A multi-processor computer system (100), comprising:
a plurality of communicatively coupled (160) processors (110_{1-N}):
each coupled to a common motherboard (120), and
each associated with a memory (140_{1-N}); and
a boot code (130), the boot code executable from at least one of a standard mode and an independent mode;
wherein the plurality of communicatively coupled processors execute one instance of the boot code in standard mode; and
wherein at least a portion of the plurality of communicatively coupled processors execute one instance of the boot code in independent mode.

2. The multi-processor computer system of claim 1, further comprising an input/output (I/O) controller (170) coupled to at least one of the plurality of communicatively coupled processors (110_{1-N}).

3. The multi-processor computer system of claim 1, wherein one I/O controller (170) is enabled in standard mode.

4. The multi-processor computer system of claim 2, wherein at least two I/O controllers (170) are enabled in independent mode.

5. The multi-processor computer system of claim 1, the plurality of communicatively coupled processors coupled (160) using an interruptible processor-to-processor interconnect.

6. The multi-processor system of claim 5, wherein the interruptible processor-to-processor interconnect comprises one of a Quick Path Interconnect or a Hyper Transport.

7. The multi-processor computer system of claim 1, further comprising a partitioning module (210), the partitioning module including:
a boot code (220) associable with at least one of the plurality of communicatively coupled processors in the independent mode; and
at least one input/output (I/O) controller (230) associable with at least one of the plurality of communicatively coupled processors in the independent mode.

8. The multi-processor computer system of claim 7, the partitioning module (210) couplable to the motherboard (120).

9. The multi-processor computer system of claim 1, further comprising a user interface (240) to permit a user to reversibly switch between the standard mode and the independent mode.

10. The multi-processor computer system of claim 7, further comprising detection logic (250) to:
detect the presence of the partitioning module; and
enter the independent mode upon detecting the partitioning module.

11. A multi-processor computer method, comprising:
entering (310) an independent mode;
retrieving (320) a first boot code from a first boot code storage device;
executing (330) the first boot code on a first group of processors selected from a plurality of processors coupled to a motherboard;
retrieving (340) a second boot code from a second boot code storage device; and
contemporaneously executing (350) the second boot code on a second group of processors selected from the plurality of processors coupled to the motherboard.

12. The multi-processor computer method of claim 11, further comprising:
disposing a partitioning module on the motherboard;
the partitioning module including the second boot code storage device and the second boot code.

13. The multi-processor computer method of claim 11 further comprising:
coupling (410) a first I/O controller to the first group of processors; and
accessing (420) at least one I/O device via the first I/O controller.

14. The multi-processor computer method of claim 12, further comprising:
coupling (430) a second I/O controller disposed within the partitioning module to the second group of processors; and
accessing (440) at least one I/O device via the second I/O controller.

15. A multi-processor computer system, comprising:
two communicatively coupled processors (110), each coupled to a common motherboard (120);
a first boot code (130);
a first memory (140) accessible to a first (110₁) of the two communicatively coupled processors;
the two communicatively coupled processors configured to execute one instance of the first boot code when in a standard mode;
a first input/output (I/O) controller (170), couplable to the two communicatively coupled processors when in the standard mode;
a partitioning module (210), the partitioning module including:
a second boot code (220) and a second input/output controller (230), couplable to the second processor when in the independent mode;
the second of the two communicatively coupled processors configured to execute one instance of the second boot code when in an independent mode; and
a user interface (240) to permit a user to reversibly alternate between at least one of the standard mode or the independent mode.
